(19) United States
(12) Patent Application Publication
(10) Pub. No.: US 2006/0010019 A1
(43) Pub. Date: Jan. 12, 2006

(54) Method and system for providing customer service for a household appliance

(76) Inventors: Scott H. Phillips, St. Joseph, MI (US); David J. Winenger, Evansville, IN (US); Stanley Buntin, Stevensville, MI (US); Jerrold D. Clemons, Frisco, TX (US); Steven A. Gier, Tinley Park, IL (US); James F. Sander, Canton, GA (US); John C. Philipp, Sonoma, CA (US); Justin Newby, Sands Point, NY (US)

Correspondence Address: WHIRLPOOL PATENTS COMPANY - MD 0750, Suite 102, 500 Renaissance Drive, St. Joseph, MI, 49085, US

(21) Appl. No.: 10/854,069

(22) Filed: May 26, 2004

(51) Int. Cl. G06F 17/60

(52) U.S. Cl. 705/7

(57) ABSTRACT

In a customer service system and method, a customer of a household appliance has a personal service representative who is a main contact for the customer. The customer has access to at least part of a customer master data file that contains information related to the customer and to the household appliance. The master data file can be accessed through a website that is dedicated to the customer service system. Further, the customer can receive a home visit after the household appliance has been delivered and installed to ensure that the household appliance is properly installed and that the customer knows how to operate the household appliance. The customer service system and method can also include certified delivery and installation and certified service.

### BACKGROUND OF THE INVENTION

1. Field of the Invention

The invention relates to customer service for a household appliance. In one aspect, the invention is a system for providing customer service for a household appliance. In another aspect, the invention is a method for providing customer service for a household appliance. In yet another aspect, the invention is a method for providing personalized customer service for a specific brand of household appliances sold to a customer by a wholesaler selling multiple brands of household appliances.

2. Description of the Related Art

Most modern homes are equipped with a variety of household appliances ranging from kitchen appliances, such as refrigerators and ovens, to laundry washers and dryers to home electronics. Typically, household appliances are fairly large and must be delivered and installed by the seller or by a third party. After the appliances are installed, it is commonly up to the customer to figure out how to operate the appliance. If any problems occur during use of the appliance, the customer contacts the seller, the manufacturer, or a third party to request service in their home. When the delivery and installation, operation, or service of the appliance does not proceed in a timely or effective manner or does not otherwise meet the expectations of the customer, the customer develops a poor opinion of the parties with which they are dealing, the particular household appliance, and other household appliances having the same brand name.

Common problems associated with delivery and installation include a delayed arrival or a no-show, which irritates the customer because they must remain at home while waiting for the household appliance to arrive, and inexperienced or incompetent installation personnel who incorrectly install the appliance. When the latter occurs, the customer has to contact the installation party and schedule another visit to attempt to install the appliance correctly. Further, incorrect installation can go undetected by the user and ultimately cause damage to the household appliance.

After installation, the user might not know how to operate the household appliance or might only be aware of how to use a few basic features. A common reaction to not knowing how to operate an appliance is to blame the appliance and, thus, the customer can become frustrated and dissatisfied with their purchase. By not knowing how to use all of the features of the appliance, the customer is not fully cognizant of the machine's benefits and capabilities, including those that differentiate it from other brands of household appliances. Typically, the only resource readily available for guiding the customer is the user's manual, which some users don't read or refer to when having a problem. Further, improper use can potentially damage the appliance. When the appliance will not function or functions abnormally, the customer makes a service request, and the service visit commonly has complaints similar to those described above for delivery and installation. In some situations, the user may believe that the appliance is not working properly and request a repair service, when the problem is nothing more than the user lack of knowledge of the use and operation of the appliance.

The customer often dreads having to contact the seller, the manufacturer, or a third party to request a service visit or assistance with the household appliance. In recent times, a number of companies have begun to utilize automatic phone answering systems or voice recognition units that direct the customer to a department related to the customer's question or request. Unfortunately, these systems have several problems, such as directing a customer to one or more incorrect departments, dropping the customer's call during call transfer, and making the customer wait for an extended period of time before talking to a live human. When the customer eventually speaks to the correct person in the correct department and requests information or service, the person usually records information about the customer and any scheduled service visit, and the customer is at the mercy of the person to correctly record this information. If information that affects the customer directly, such as the date/time of a service visit, is entered wrong and is not discovered, then the customer suffers when the incorrect information causes further problems or inconveniences.

Ultimately, there are several things that can go wrong or fail to meet expectations when a customer deals with the delivery and installation, use, or service of a household appliance, and these experiences eventually lead to unhappy customers. Unhappy customers are detrimental to the marketing of household appliance brands. Not only is it unlikely that the customer will not purchase the same brand of household appliances again, the customer will most definitely not recommend the brand to others and might even speak poorly of the brand to other potential buyers. Excellent customer service that meets and exceeds customer expectations is critical for successful sales of a household appliance brand.

### SUMMARY OF THE INVENTION

A method according to the invention for providing customer service for a household appliance sold at a point of sale (POS) to a customer and subsequently installed in the customer's home comprises visiting the customer's home after the installation of the household appliance to conduct at least one of the following services: checking the household appliance for proper installation, checking the household appliance for proper operation, and instructing the customer on the operation of the household appliance. Optionally, all of the services can be conducted during the visit.

A representative of a wholesaler of the household appliance can conduct the visit. The representative can be one of an employee or non-employee of the wholesaler.

The method can further comprise recording product information for the household appliance during the visit. The product information can be recorded on a client device capable of being connected to a server having an associated data source for storing the recorded product information. The client device can be at least one of a: portable computer, hand-held computing device, a personal digital assistant, or cellular phone. The client device can be wirelessly connected to the server to dynamically update the data source with the product information.

The method can further comprise accessing customer information containing at least one of customer personal information and product information for the household appliance during the visit. The method can further comprise confirming at least one of the customer information and product information during the visit. Alternatively, both the customer information and product information can be confirmed during the visit.

The method can further comprise explaining the service benefits to the customer for the household appliance.

The method can further comprise responding to a problem identified when providing one of the services. The response to the identified problem can comprise at least one of: accessing help information and placing a service request for service on the household appliance.

Accessing help information can comprise at least one of: placing a call to a technical specialist and accessing problem solving guides. Accessing problem solving guides can comprise accessing a knowledge base. The knowledge base can be updated with a description of the identified problem. The placing of a call to the technical specialist can comprise a conference call with the customer.

The customer can be provided access to information, or a portion of the information, related to the scheduling of the service request. Access can be provided to the information for the service request through a communications network, such as the Internet. The method can further comprise receiving feedback from the customer regarding the information for the service request and incorporating the customer feedback into the service to be provided in response to the service request. Incorporating the feedback into the service can comprise altering at least one of the: service on the household appliance and the date or time of a service visit. The method can further comprise providing the service visit on the household appliance in accordance with the information for the service request.

The method can further comprise updating a knowledge base with at least one of the information for the service request and the feedback. The customer can be provided with access to at least a portion of the knowledge base. Others can be provided with access to the at least a portion of the knowledge base.

The placing of the service request can comprise confirming the date of the service visit with the customer. The customer can be contacted after the service visit to determine the status of the problem. Contacting the customer can comprise at least one of: a home visit, a telephone call, and an e-mail.

The method can further comprise making a visual recording of the visit. At least a portion of the visual recording can be made available to at least the customer. At least a portion of the visual recording can be used to form a reality-based program.

The checking of the household appliance for proper installation can comprise checking at least one of the temperature and humidity of the household appliance. The instructing of the customer on the operation of the household appliance can comprise conducting an overview of the basic operation of the household appliance and/or an overview of special features of the household appliance.

The method can further comprise scheduling the visit with the customer prior to the visit. The scheduling of the visit can comprise communicating with the customer to set the date of the visit. The communication can comprise at least one of telephoning or e-mailing the customer. The method can further comprise reviewing customer information at least one of: prior to the visit and during the visit. The customer information can be updated in response to the visit. The customer information can be updated by updating a customer service database. The method can further comprise providing the customer with access to at least a portion of the customer information.

In another aspect, a method according to the invention for providing customer service for a household appliance sold to a customer comprises receiving a service request for providing service to the household appliance; compiling information regarding the service request; providing the customer with access to the compiled service request information; and receiving feedback from the customer regarding the compiled service request information.

The method can further comprise updating the compiled service request information based on the feedback from the customer. The method can further comprise incorporating the customer feedback into the service to be provided in response to the service request. Incorporating the feedback into the service can comprise altering at least one of the: service on the household appliance and the date or time of a service visit. The method can further comprise providing service on the household appliance in accordance with the compiled service request information.

Access can be provided to only a portion of the compiled service request information. Access can be provided to the compiled service request information through a communications network. The communications network can be the Internet.

The method can further comprise updating a knowledge base with at least one of the compiled service request information and the feedback. The customer can be provided with access to at least a portion of the knowledge base. Others can be provided with access to the at least a portion of the knowledge base.

In yet another aspect, a method according to the invention for providing personalized customer service for a specific brand of a household appliance sold to a customer by a wholesaler selling multiple brands of household appliances comprises providing multiple service representatives dedicated to the specific brand; assigning one of the multiple service representatives to the customer to personally manage the customer service for the specific brand; and providing access by the customer to customer information related to the customer service. Access can be provided to only a portion of the customer information. Access to the customer information can be provided through a communications network. The communications network can be the Internet.

The method can further comprise receiving feedback from the customer regarding the customer information. The customer information can comprise personal information and product information or a service request for the household appliance. The method can further comprise updating the customer information based on the feedback from the customer. The method can further comprise providing a service visit on the household appliance in accordance with the updated customer information. Updating the customer information can comprise altering at least one of the: service on the household appliance and the date or time of the service visit.

The method can further comprise updating a knowledge base with at least one of the customer information and the feedback. The customer can be provided with access to at least a portion of the knowledge base. Others can be provided with access to the at least a portion of the knowledge base.

The method can further comprise visiting the customer's home after installation of the household appliance to provide at least one of the following services: checking the household appliance for proper installation, checking the household appliance for proper operation, and instructing the customer on the operation of the household appliance. All of the services can be provided during the visit.

The services can be provided in accordance with a visit guide containing predetermined service steps. The visit guide can be personalized with at least one of personal information and product information for the household appliance to be serviced. The visit guide can be dynamically updated. The method can further comprise updating at least one of the personal information and product information in response to the home visit.

The method can further comprise recording product information for the household appliance during the visit. The method can further comprise explaining the service benefits to the customer for the household appliance.

The method can further comprise responding to a problem identified when providing one of the services. The response to the identified problem can comprise at least one of: accessing help information and placing a service request for service on the household appliance. Accessing help information can comprise at least one of: placing a call to a technical specialist and accessing a problem solving guide. The placing of a call to the technical specialist can comprise a conference call with the customer.

The method can further comprise making a visual recording of the visit. At least a portion of the visual recording can be made available to at least the customer. At least a portion of the visual recording can be used to form a reality-based program.

Access to the customer's home for providing the services can be obtained with an authorized access card.

The customer information can comprise a service request for the household appliance, and the feedback can be incorporated into the service request to update the service request. A service visit can be provided on the household appliance in accordance with the updated service request.

The method can further comprise providing household appliances of the specific brand with an enhanced warranty as compared to household appliances of the other brands. The method can further comprise installing the household appliance by a certified installation agent. The method can further comprise conducting a service visit by a service specialist to address a problem associated with the household appliance. The service specialist can have a personal computing device with access to the customer information. The personal computing device can have access to a service guide. The service guide can be updated by a knowledge base.

The method can further comprise providing a customer service website for providing access to the customer information by the customer. The customer can provide feedback regarding the customer information through the customer service website. The customer service website can comprise a service request form that can be submitted by the customer.

A system according to the invention for providing service for a household appliance sold to a customer comprises a server operably interconnected to a network having at least one client; a data source associated with the server, the data source being configured to store information representative of a service request for the household appliance and accessible by the at least one client; a feedback client operably interconnected with the network for receiving feedback information representative of a comment on the service request made by the customer. The at least one client can issue the information representative of the service request to the data source, and the feedback client can issue the at least one comment to the data source so that the customer service provided to the household appliance in accordance with the service request can be refined according to the at least one comment received from the feedback client.

The information representative of the service request can comprise at least the information needed to provide service on the household appliance. The information representative of the service request can comprise at least one of: description of the problem with the household appliance; model of the household appliance; scheduling information for a service visit; customer personal information; and service provider information.

The information representative of the service request can be stored in an abbreviated form. The abbreviated form can comprise at least one of: acronyms and service codes. The system can further comprise a translating client accessible by the data source and the feedback client to convert the abbreviated form to a language understandable by the customer. The language can be at least one of: English, German, Spanish, Italian, and French. The translating client can create the feedback information representative of the customer comment by converting the customer comment into the abbreviated form.

The translating client can comprise at least one of: a human, a microprocessor, or software. The at least one client can comprise at least one of: a human, a microprocessor, or software. The human can receive the service request and use the at least one client to enter the information representative of the service request into the data source. The system can further comprise a voice network over which the human receives the service request. The at least one client can comprise an Internet browser.

The server can comprise a web server. The data source can comprise at least one database. The feedback client can be operably interconnected to the at least one database so that the customer can access at least a portion of the data source. The feedback client can be associated with the data source such that the customer comment can be used to update the data source. The database can reside on the server.

The network can comprise at least one of: the Internet, a Local Area Network, a wireless network, and the World Wide Web. The feedback client can comprise a web browser operably connected to the network. The system can further comprise a personal computing device on which the web browser resides. The personal computing device can comprise at least one of: a personal computer, a handheld computer, a personal digital assistant, a cellular phone. The feedback client further can comprise a web site associated with the server so that the data source can be viewed on the web site using the web browser.

The system can further comprise at least one data file containing information for conducting a home visit of the household appliance. The at least one data file can comprise information for conducting at least one of the following: checking the household appliance for proper installation, checking the household appliance for proper operation, and instructing the customer on the operation of the household appliance. The system can further comprise a computing device on which the at least one data file resides. The computing device can be operably connected to the network to permit the updating of the at least one data file via the network. The computing device can comprise at least one of a personal computer, a handheld computer, a personal digital assistant, a cellular phone.

The at least one data file can be associated with the data source so that the at least one data file can be updated from the data source. The data source can include at least one of customer personal information and product information for the household appliance so that the at least one data file can be personalized for at least one of the customer and the household appliance for the home visit. The system can further comprise a remote client residing on the computing device and providing an interface with the at least one file and permitting the reading and writing of the data file so that the at least one data file can be updated by the remote client. The remote client can be operably coupled to the network to permit the updating of corresponding data in the data source and the at least one data file when the data file is written to by the remote client.

The data source can comprise at least one master data file to form the at least one data file that can be downloaded to the computing device over the network. The data source can further comprise a compilation of the household appliance information and feedback information which is used to update the master data file.

### BRIEF DESCRIPTION OF THE DRAWINGS

In the drawings:

FIG. 1 is a schematic of a customer service system according to the invention and comprising several elements for providing customer service for a household appliance;

FIG. 2 is a schematic of a people network of the customer service system of FIG. 1, wherein the people network interacts with a customer during and after purchase of the household appliance;

FIG. 3 is a schematic of a communications network of the customer service system of FIG. 1, wherein the communications network includes a client, a feedback client, a translating client, a server, and a remote client;

FIG. 4 is a schematic illustrating interaction between a portion of the communications network of FIG. 3, particularly the client, the feedback client, the translating client, and the server, and a portion of the people network of FIG. 2;

FIG. 5 is a schematic illustrating communication between a portion of the network of FIG. 3, particularly the client, the server, and the remote client, and a portion of the people network of FIG. 2;

FIG. 6 is a schematic illustrating general flow of events that occur during implementation of the customer service system of FIG. 1, wherein the events include pre-registration, welcome communication, home visit setup, home visit, dedicated website account setup, and schedule service visit;

FIG. 7 is a flow chart of the pre-registration of FIG. 6;

FIGS. 8A and 8B are a flow chart of the welcome communication of FIG. 6;

FIG. 9 is a flow chart of the home visit setup of FIG. 6;

FIG. 10 is a flow chart of the home visit of FIG. 6;

FIG. 11 is a schematic of an access card that can be utilized to enter a home in the home visit of FIG. 10;

FIG. 12 is a flow chart of the dedicated website account setup of FIG. 6;

FIG. 13 is a schematic showing content of a dedicated website of the customer service system of FIG. 1; and

FIGS. 14A and 14B are a flowchart of the scheduling of a service visit from FIG. 6.

### DESCRIPTION OF THE INVENTION

The invention provides a method and a system for providing customer service for a household appliance that addresses the deficiencies common to customer service and at least meets and preferably exceeds customer expectations so that customers are satisfied with not only the customer service but also with the household appliance and the household appliance brand. In general, a customer service system according to the invention ensures that a customer's experience during delivery and installation, use, and service of a household appliance, including communication associated therewith, is pleasant, efficient, and effective.

When the customer service system is utilized for a particular brand of household appliances, that brand stands apart from other brands, and potential buyers associate the brand with excellent customer service. Such brand recognition and customer satisfaction can contribute to increased sales and profits. A manufacturer of multiple brands of household appliances can utilize the customer service system to differentiate one ore more brands from its other brands. While it is preferred that the customer service system is utilized for a particular brand of household appliances, it is well within the scope of the invention for the customer service system to be applied to more than one household appliance brand.

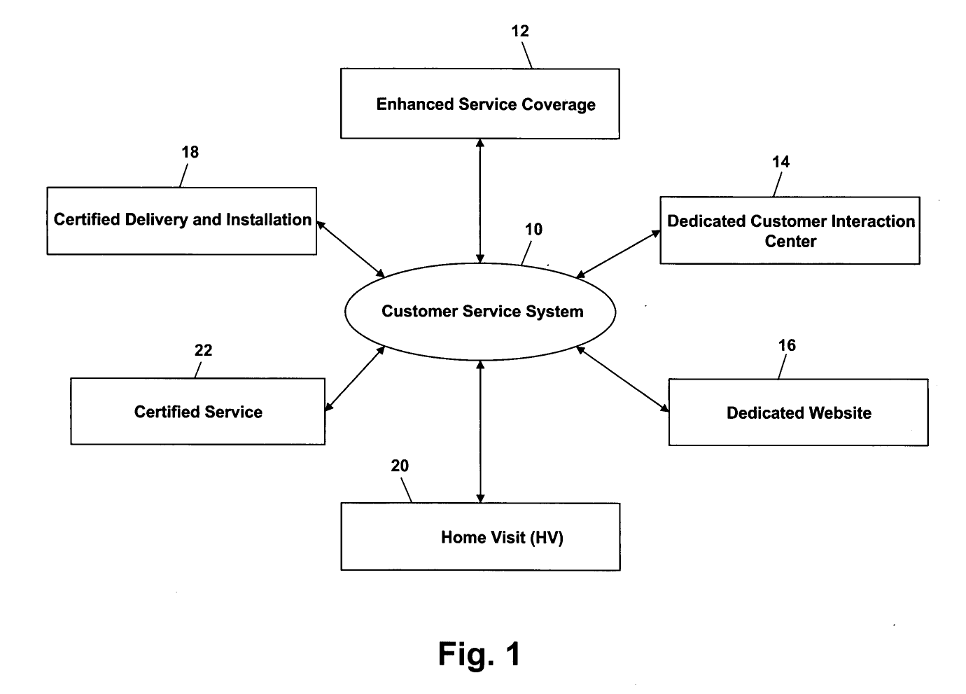

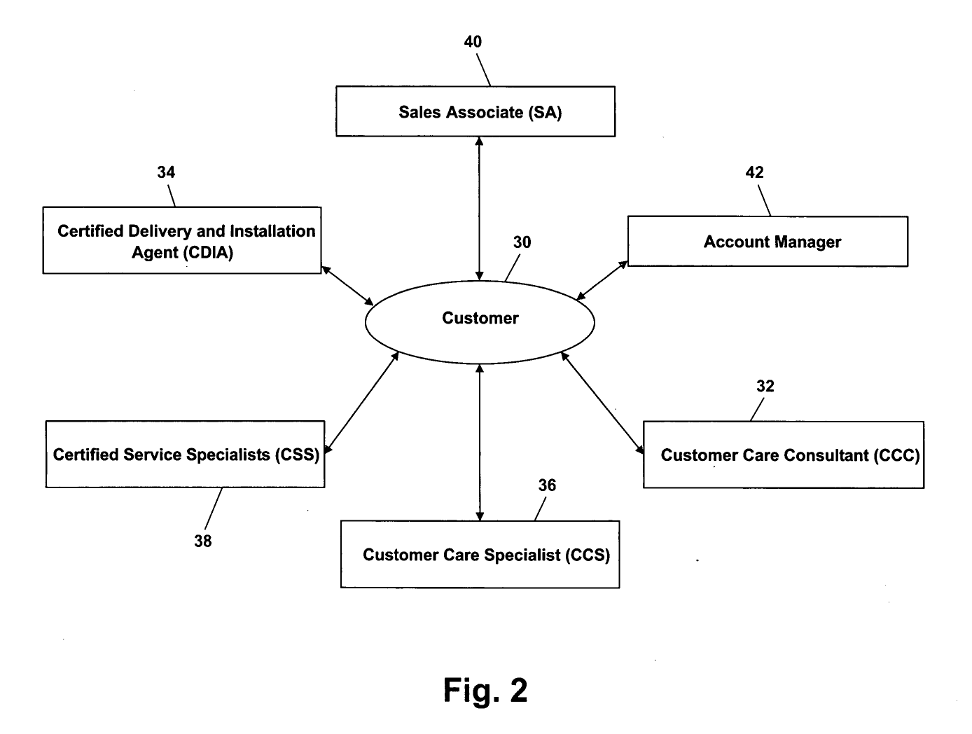

Referring now to the figures, FIG. 1 schematically illustrates a customer service system 10 having several elements that, either taken together or individually, provide superior customer service to a customer 30 during and after purchase of a household appliance, and FIG. 2 schematically shows a people network comprising people that potentially interact with the customer 30 during implementation of the customer service system 10. The elements of the customer service system 10 comprise enhanced service coverage 12, a dedicated customer interaction center 14, a dedicated customer service website 16, certified delivery and installation 18, a home visit 20, and certified service 22.

The enhanced service coverage 12 is coverage beyond a standard warranty on the household appliance or beyond a warranty for a household appliance of other brands. The enhanced service coverage 12 can extend the warranty beyond its normal duration and can guarantee to pay for parts and service not typically covered by standard warranties. For example, with the enhanced service coverage 12, the customer is not financially responsible for correction of installation problems or for parts and labor to remedy problems associated with functional failures or improper usage of the household appliance.

The dedicated customer interaction center (CIC) 14 is one or more communication centers staffed with well-trained customer care consultants (CCC) 32 that are dedicated to communicating with and assisting the customer 30. The CIC 14 both initiates communication with the customer 30 and can be contacted by the customer 30. When the customer 30 contacts the CIC 14 by telephone, the customer 30 immediately communicates directly with a CCC 32 rather than with a voice recognition unit. The CIC 14 can have extended hours of operation as compared to a standard eight hour business day, and the customer 30 can leave a message during off-hours and can indicate if the communication is an emergency that requires prompt attention. The CCC 32 is preferably familiar with all aspects of the household appliances associated with the customer service system 10, is aware of customer expectations, and is committed to delivering world class service. The CCC 32 is a service representative that manages the customer service system 10 for the customer 30 and orchestrates interaction with the customer 30. The customer 30 is preferably assigned to a personal CCC 32 that serves as a main point-of-contact for the customer service system 30. When the customer 30 needs assistance related to the household appliance, the customer 30 knows to directly contact the assigned CCC 32 and, therefore, associates the CCC 32 with the customer service system 10.

The customer can also communicate with the CCC 32 though the dedicated website 16, which is accessible to the customer 30 by a username and password. The dedicated website 16 facilitates several communication functions and also offers a plentitude of information that supplements the information in the household appliance user's manual. Further description of the dedicated website 16 is presented hereinafter.

After the customer 30 purchases the household appliance, a certified delivery and installation agent (CDIA) 34 comes to the home to deliver and install the household appliance during the certified delivery and installation 18 of the customer service system 10. The CDIA 34 is very knowledgeable about the household appliance, trained to deliver the household appliance to the home without causing any damage thereto, and trained to properly install the household appliance such that it functions correctly and is unlikely to require a follow-up installation visit.

The home visit 20 of the customer service system 10 occurs after the household appliance has been delivered and installed, whether by the CDIA 34 or by another party. In the home visit 20, a customer care specialist (CCS) 36 comes to the home of the customer 30 to discuss the customer service system 10 and to perform one or more services. For example, the CCS 36 can check the household appliance for proper installation, determine whether the customer 30 is properly operating the household appliance, and instruct the customer 30 on the operation of the household appliance. The home visit 20 is preferably performed with the assistance of home visit guides that are personalized for the customer 30 and the particular household appliance or appliances purchased. The home visit 20 not only provides a customer service benefit that goes above and beyond conventional customer service, but it also reduces or prevents potential future service visit requests and service visits to fix problems associated with improper installation and incorrect usage of the household appliance. The home visit 20 will be described in more detail hereinafter.

When a service visit is required, the household appliance is eligible for the certified service 22 of the customer service system 10. The certified service 22 is an expedited repair service, and the certified service 22 is preferably conducted by a certified service specialist (CSS) 38 who has been specially trained by the manufacturer of the particular brand of the household appliance. The CSS 38 is able to promptly respond to the service request and preferably has on-hand stocks of parts for the household appliance for the expedited repair service.

In addition to the CCC 32, the CDIA 34, the CCS, 36, and the CSS 38, the customer can interact with other persons in the people network associated with the customer service system 10, as shown in FIG. 2. For example, at a point-of-sale (POS), such as a retail store or at a wholesaler store, the customer purchases the household appliance from a sales associate 40. The sales associate 40 can be any person with whom the customer 30 interacts while buying the household appliance. Additionally, an account manager 42, who is a regional sales representative for the particular brand of the household appliance, might deal directly or indirectly with the customer 30 during the purchase of the household appliance.

The people network has been described in part as comprising various individuals, such as the CCC 32, the CDIA 34, the CCS, 36, and the CSS 38, who execute the elements of the customer service system 10. However, it is within the scope of the invention for a single person to carry out more than one of the elements of the customer service system 10. For example, the person who conducts the home visit 20 can also execute the certified service 22 and/or the certified delivery and installation 18. Similarly, the customer care consultant 32 can conduct the home visit 20 and so on. In some instances, it could be preferred that the same person is involved in more than one element of the customer service system 10 so that the customer 30 is familiar with that person and is able to associate that person and their dedication to customer service with the household appliance and the brand of the household appliance. Further, the persons in the people network can be employees or non-employees of the manufacturer, the wholesaler, the retailer, or of another party. For example, the persons who conduct service on the household appliance can be employees of a third party service company. Meanwhile, the person who conducts the home visit can be a representative of the wholesaler. For explanatory purposes, particular elements of the customer service system 10 are described herein as being associated with particular people (CCC 32, CDIA 34, CCS, 36, and CSS 38). The description of the customer service system 10 in this manner is not intended to limit the invention as such.

The customer service system 10 has been described as comprising the six elements shown in FIG. 1. However, it is within the scope of the invention for the customer service system 10 to involve any combination of these elements and any additional elements. For example, the customer service system 10 can comprise only the dedicated CIC 14 and the home visit 20. Additionally, the availability of the elements of the customer service system 10 can vary according to geographic location. Further, the different elements can be available for different household appliances of the same brand. For example, the customer service system 10 for a higher end model of a household appliance might comprise more of the elements than the customer service system 10 for a lower end household appliance. Alternatively, the number of and types of elements associated with the customer service system 10 can vary among different brands of household appliances from the same manufacturer to help facilitate brand differentiation. For expository purposes, the customer service system 10 is described herein as comprising all of the elements shown in FIG. 1.

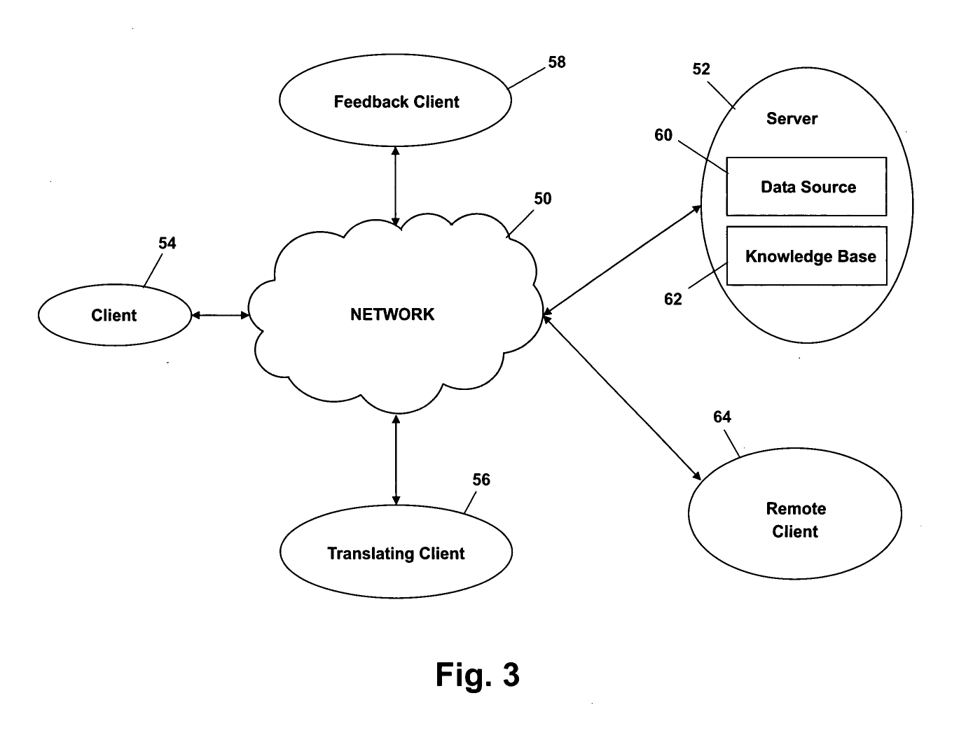

Referring now to FIG. 3, the customer service system 10 further comprises a communications network 50 to facilitate communication within the people network shown in FIG. 2, to facilitate execution of the elements shown in FIG. 1, and to store, transfer, and enable access to data, which is preferably in electronic format, associated with the customer 30 and the household appliance. The communications network 50 can comprise both humans and electronic machines, wherein the humans can communicate with other humans, the humans can communicate with the electronic machines, and the electronic machines can communicate with other electronic machines.

As shown in FIG. 3, the communications network 50 comprises a server 52 with a client system including at least one client device, such as a client 54, a feedback client 56, a translating client 58, and a remote client 64, all operably interconnected. The server 52 comprises a data source 60 and a knowledge base 62, each of which can have several databases associated therewith. Alternatively, the data source 60 and knowledge base 62 can be contained in the same customer service database. The client 54 can access the server 52 to issue information to or receive information from the data source 60 and/or the knowledge base 62.

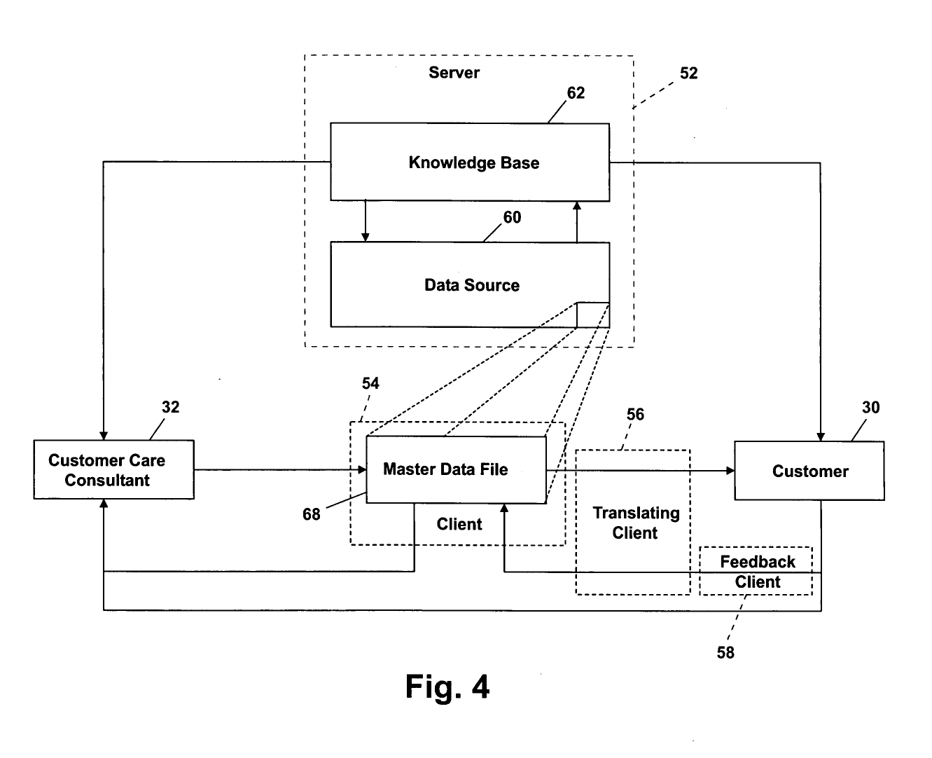

The data source 60 stores customer information containing personal information related to the customer 30 and product information related to the household appliances, or products, that the customer 30 owns. The personal information can include, for example, contact information, demographic data, and personal preferences, while the product information can include model number, style number, product description, historical service information, historical operation information, information about current requests for service, and information about currently scheduled service visits. The personal information and the product information for a particular customer 30 and the household appliances owned by that particular customer 30 are contained in a customer master data file 68 (FIG. 4).

The knowledge base 62 stores general data about the household appliances associated with the customer service system 10. The knowledge base 62 compiles data from the manufacturer of the household appliance brand, from the experiences of several customers 30 by accessing the data source 60 and the contents of the customer master data files 68, and from the experiences of others in the people network and makes the data available for use in answering questions and addressing problems related to the household appliance. Further, the knowledge base 62 can contain answers to frequently asked questions about the household appliance, service guides, home visit guides, problem solving guides, forms, such as service request forms, and questionnaires or surveys related to the customer 30 and to the household appliance. The knowledge base 62 is essentially a warehouse of reference data available to the people network to facilitate execution of the customer service system 10. Optionally, the knowledge base 62, or portions thereof, can be available to others that are not included in FIG. 2, such as a third party. Because the knowledge base 62 is constantly interacting with the data source 60, the knowledge base 62 is continuously updated to improve its content. The interaction and updating can be done by software or by a human.

The customer 30 can access the customer master data file 68 or at least a portion thereof. By giving the customer 30 the ability to view portions or the entirety of the customer master data file 68, the customer 30 can verify if the information in the customer master data file 68 is accurate and can monitor its contents, such as the status of the scheduled home visit 20, service requests, scheduled service visits, product information, and the like. The information in the master data file 68 is preferably stored in an abbreviated or short-hand form, such as acronyms and codes, including service codes. The translating client 56 converts the abbreviated form to a language, such as English, German, French, Spanish, Italian, etc., that is understandable to the customer 30. Preferably, the customer 30 accesses the customer master data file 68 through the dedicated website 16.

The customer 30 can provide feedback related to the customer master data file 68 or to any aspect of the customer service system 10 through the feedback client 58. The feedback client 58 receives feedback information from the customer 30 and submits it to the data source 60. The feedback information contains information representative of a comment from the customer 30. The comment can relate to any aspect of the customer service system 10 or the household appliance associated therewith. For example, the customer 30 can provide feedback on the accuracy of the personal information or the product information in the master data file 68. The feedback information can be a service request containing information needed to provide service on the household appliance. Examples of such information include personal information, a description of the problem, a model number of the household appliance that has the problem, scheduling information for the service visit, and service provider information. Further, the feedback information can be the customer's opinion after experiencing one or more of the elements of the customer service system 10, such as the home visit 20. The feedback information is converted from the language used by the customer 30 to the abbreviated form by the translating client 56 so that the feedback information can be submitted to and understood by the data source 60.

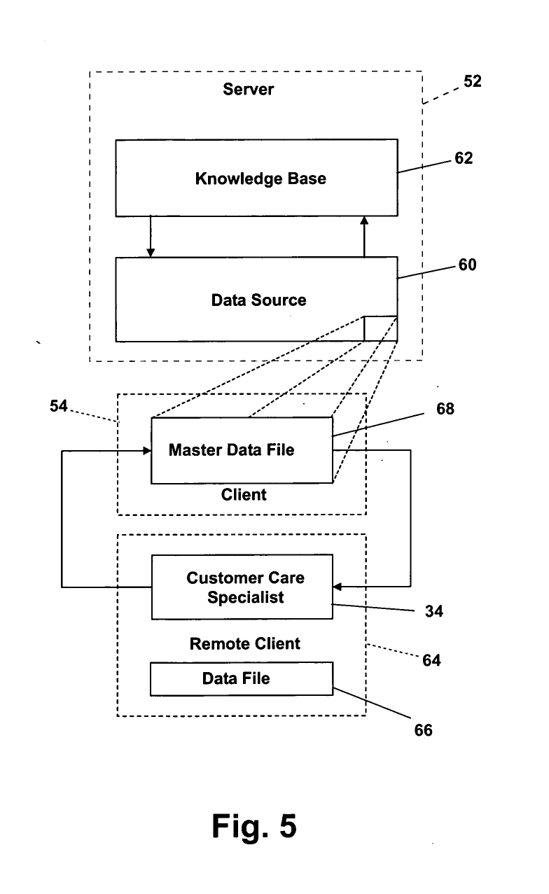

The remote client 64 of the communications network 50 can access a customer data file 66 (FIG. 5) that is formed by the customer master data file 68 in the data source 60 for use separate from the data source 60. The remote client 64 provides an interface with customer data file 66 and can read from and write to the customer data file 66, which is thereafter submitted to the data source 60 to update the master data file 68. The remote client 64 and the customer data file 66 can be used within the communications network 50 or outside the communications network 50. In the latter case, the remote client 64 is reconnected to the communications network 50 to transfer or update information obtained while outside the communications network. For example, the remote client 64 can reside on a personal computing device, such as a personal computer, a handheld computer, a personal digital assistant, or a cellular phone, operably connected to the communications network 50 and utilized by the CCS 36 during the home visit 20. For the home visit 20, the customer data file 66 can contain the personal information, the product information, the home visit guides personalized for the customer 30, and any other information that is of assistance during the home visit 20. The personal computing device can also be utilized by the CCS 38 during the certified service 22, wherein the customer data file 66 would also include guides, such as the service guides and the problem solving guides.

The communications network 50 can comprise any system that enables communication between the server 52, the client 54, the translating client 56, the feedback client 58, and the remote client 64. For example, the communications network 50 can comprise the Internet, the World Wide Web (WWW), a Local Area Network (LAN) or a wireless network, or combinations thereof. The communications system 50 can also include a voice network to enable communication between humans. The voice network can be a conventional telephone network or Internet telephony.

The client 54, the translating client 56, and the feedback client 58 can comprise any being or device able to communicate and perform its intended function in the communications network 50. For example, the client 54, the translating client 56, and the feedback client 58 can each comprise a human, an electronic device or system, or combinations thereof. The electronic device or system can be a microprocessor or software and can reside on a personal computing device, such as a personal computer, a handheld computer, a personal digital assistant, or a cellular phone. When the communications network 50 comprises the Internet and/or the WWW, any of the client 54, the translating client 56, and the feedback client 58 can comprise an Internet browser or a web browser, respectively, and the server 52 can be a web server. The web browser can be used view the dedicated website 16.

FIG. 4 schematically illustrates communication between the customer 30 and the communications network 50 and particularly how the customer 30 accesses the customer master data file 68 and provides feedback to the master data file 68. As described above, the server 58 houses the data source 60 and the knowledge base 62, which communicate with each other to share and update information. The data source 60 contains the customer master data file 68, which usually stores personal information and product information in the abbreviated form. The customer 30 can access at least a portion of the customer master data file 68 after it has been translated into an understandable language by the translating client 56. For example, the translating client 56 can take the abbreviated form of the information and convert it to a narrative. The customer 30 can provide feedback information on the personal information and the product information in the customer master data file 68 or on other aspects of the customer service system 10, or submit a service request through the feedback client 58. The translating client 56 converts the feedback information to the abbreviated form, and the feedback information is submitted to the customer master data file 68 in the data source 60. The knowledge base 62 can access the data source 60 to update and improve the knowledge base 62. Preferably, the customer 30 accesses the customer master data file 68 and provides the feedback information through the dedicated website 16. The customer 30 can also access the knowledge base 62, or portions thereof, such as through the dedicated website 16. However, the customer 30 can also directly contact the CCC 32 through electronic or voice means. The CCC 32 has access to the same information as the customer 30 in the form of the customer master data file 68. The CCC 32 can both access and update the customer master data file 68. Consequently, the customer 30 and the CCC 32 can effectively communicate with each other, and the customer 30 is given access to the most updated information. Thus, the customer 32 can provide feedback on the customer's personal information, especially if the personal information contains any inaccuracies or is missing information. When communicating with the customer 30, the CCC 32 can also access the knowledge base 62 to help answer any questions from the customer 32.

Communication between the server 52 and the remote client 64 is schematically illustrated in FIG. 5. For exemplary purposes, the communication is described herein as being associated with the CCS 34 for conducting the home visit 20. The CCS 34 is equipped with the personal computing device on which the remote client 64 resides. The remote client 64 accesses the customer data file 66 that is formed by the customer master data file 68 in the data source 60. The CCS 34 can utilize and update the customer data file 66 through the personal computing device. When the CCS 34 is done using the customer data file 66, such as when the home visit 20 is complete, the remote client 64 sends the customer data file 66 back to the server 52, where the customer master data file 68 is updated based on the updated customer data file 66.

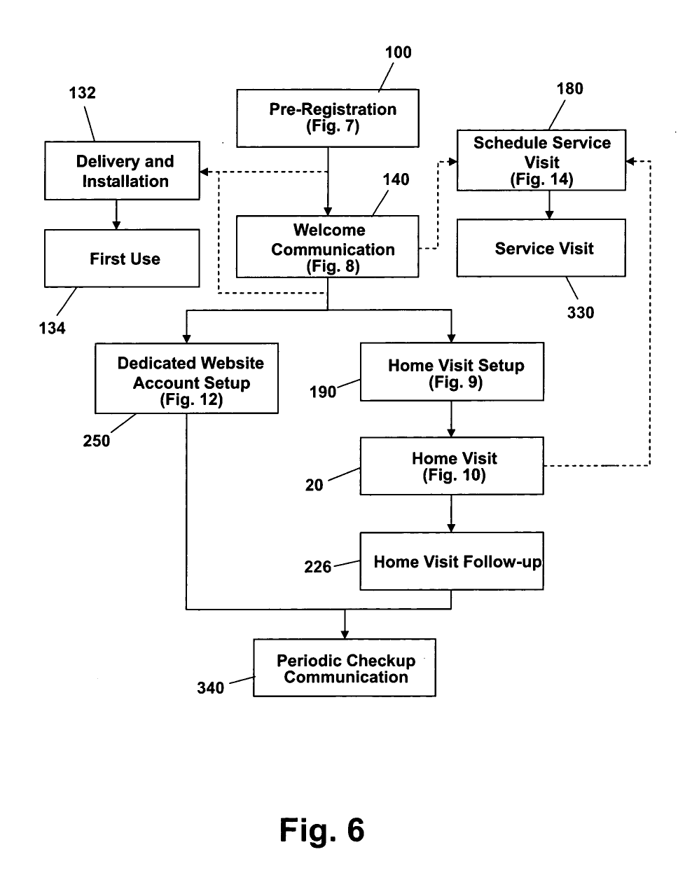

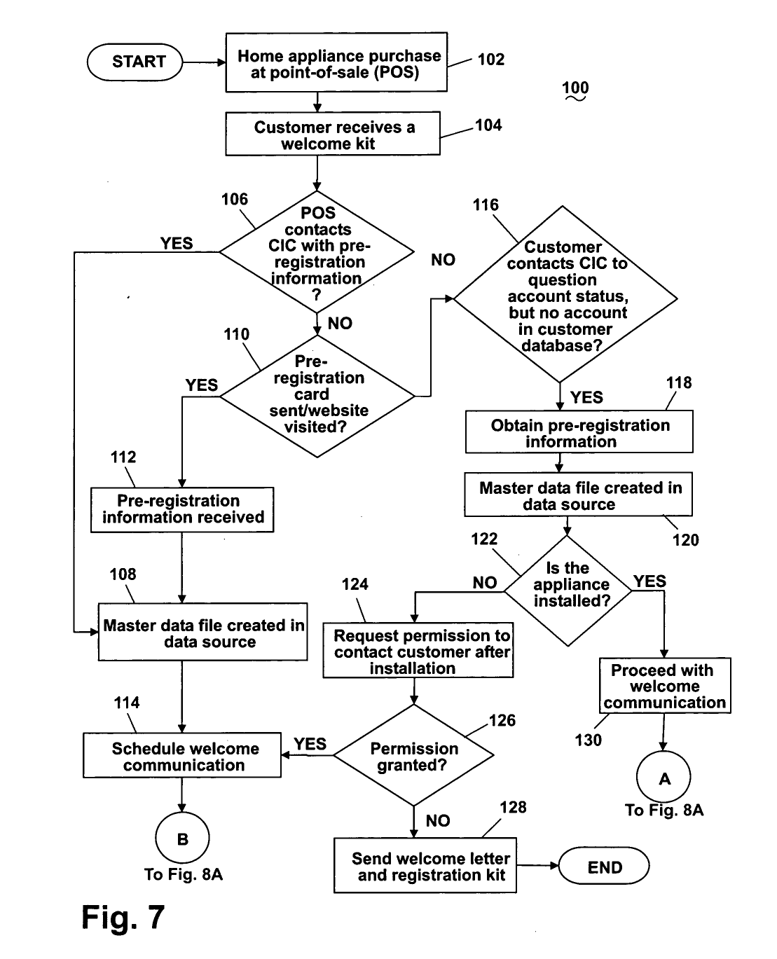

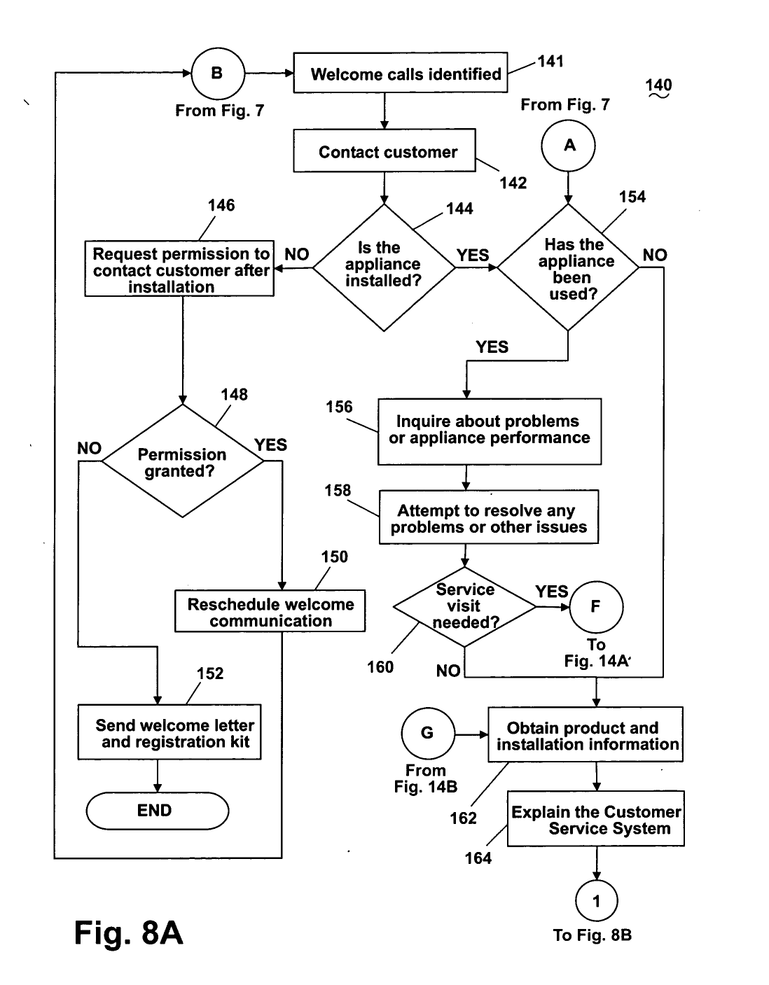

Referring now to FIGS. 6 and 7, the customer service system 10 initiates with pre-registration 100 when the customer 30 purchases the household appliance at the POS in step 102. After purchase, the customer 30 receives a welcome kit in step 104, preferably at the POS. The welcome kit contains literature describing the customer service system 10 and a pre-registration card. The pre-registration card can be a physical card, such as a post card, that can be mailed or it can be an information card directing the customer 30 to a website. The pre-registration card and the website request pre-registration information, such as personal information about the customer 30 and product information about the purchased household appliance. The pre-registration card can be filled out at the POS or at home by the customer 30. The sales associate 40 can contact the CIC 14, such as by phone or e-mail, or can mail the pre-registration card to the CIC 14 for the customer 30. Alternatively, the customer 30 can mail the pre-registration card to the CIC 14 or contact the CIC 14, such as by phone or e-mail. If the sales associate 40 at the POS contacts the CIC 14 in step 106, then the customer master data file 68 is created in the data source 60 on the server 52 in step 108. Alternatively, if the pre-registration card is sent, whether by the sales associate 40 or the customer 30, or if the customer 30 visits the website to submit the pre-registration information in step 110, then after the pre-registration information is received in step 112, the customer master data file 68 is created in the data source 60 in step 108. After the customer master data file 68 is entered, a welcome communication 140 is scheduled in step 114.

If the customer 30 contacts, such as by telephone, the CCC 32 at the CIC 14 to inquire about the status of the customer service system account, as in step 116, but no customer master data file 68 exists for the customer 30, then the pre-registration information is obtained, for example by questioning the customer 30 and/or by contacting the sales associate 14 to confirm the purchase of the household appliance, in step 118. Using the obtained pre-registration information, the customer master data file 68 is created in the data source 60 in step 120. Since contact is already established with the customer 30, the CCC 32 determines whether or not the household appliance is installed in step 122. If the household appliance is not yet installed, then the CCC 32 requests permission to contact the customer 30 after an estimated installation date in step 124. If permission is granted in step 126, then the welcome communication 140 is scheduled in step 114. However, if permission is denied in step 126, then the customer master data file 68 is updated in step 128 to indicate that a welcome letter and registration kit should be sent to the customer 30. If it is determined in step 122 that the appliance is installed, then the welcome communication 140 can proceed in step 130. The welcome communication 140 is described in detail hereinafter.

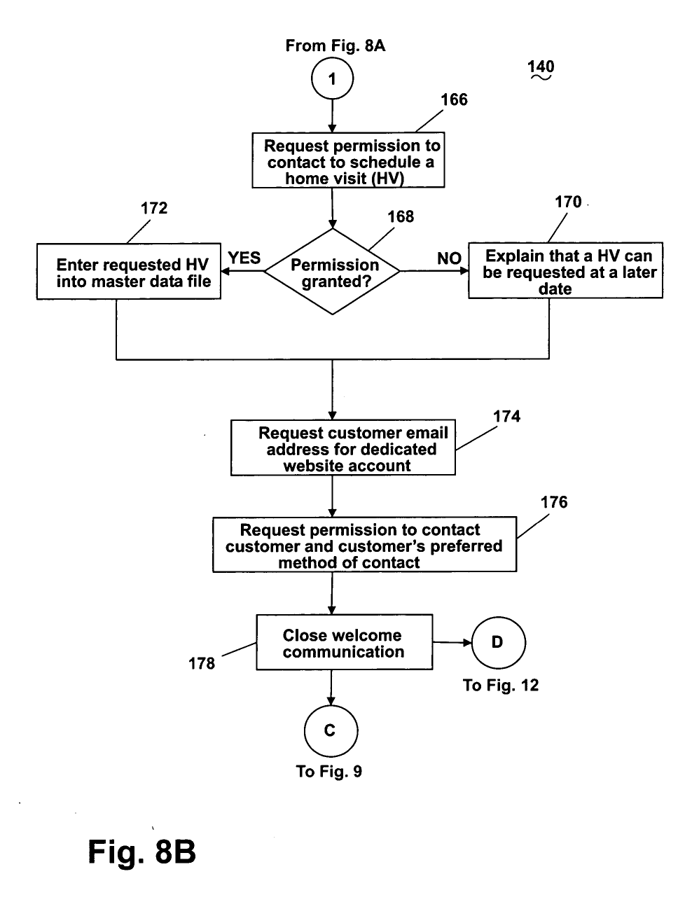

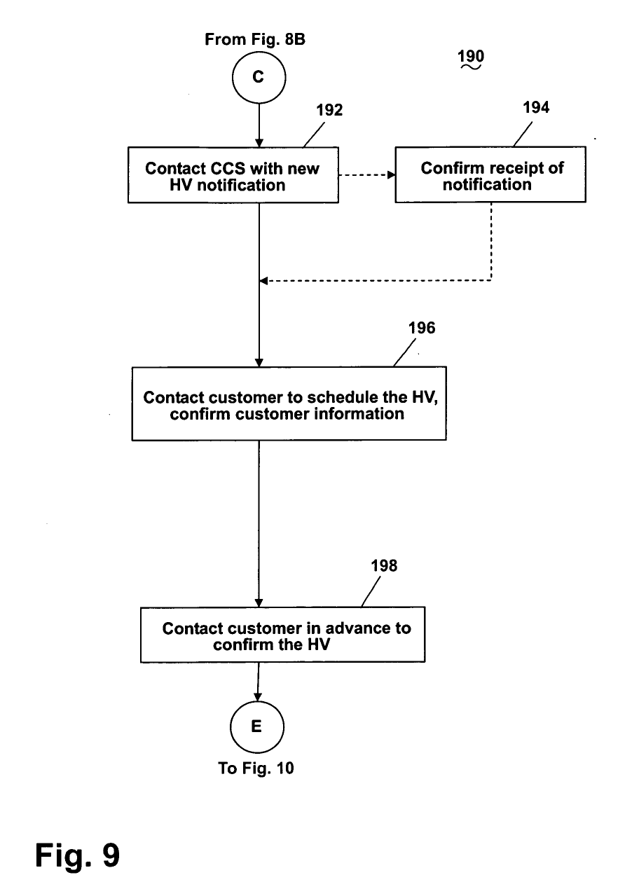

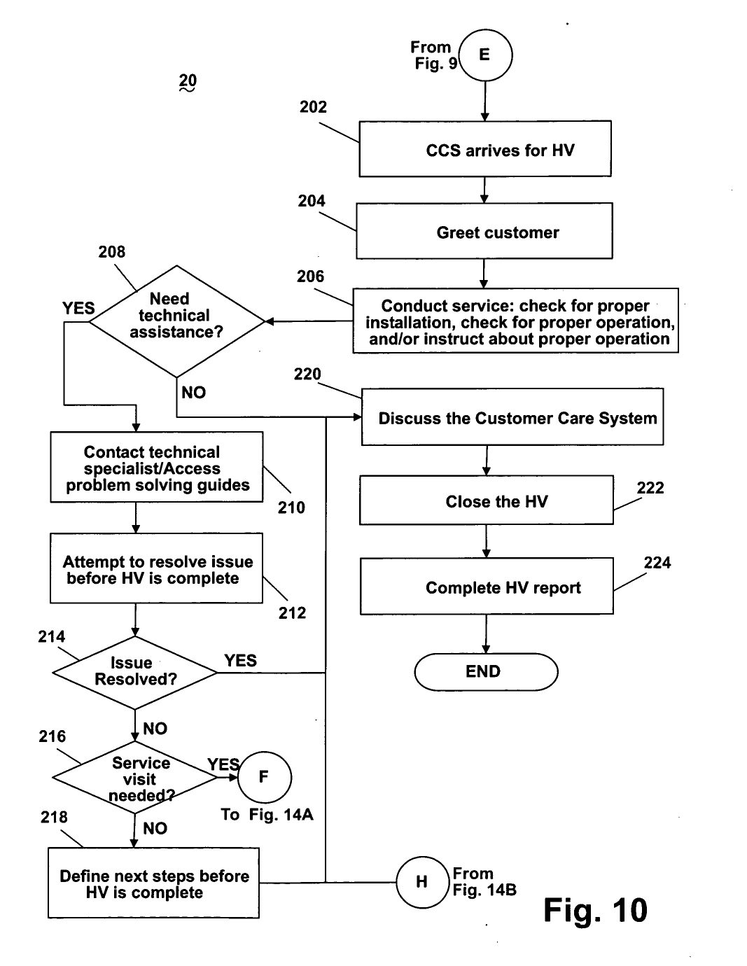

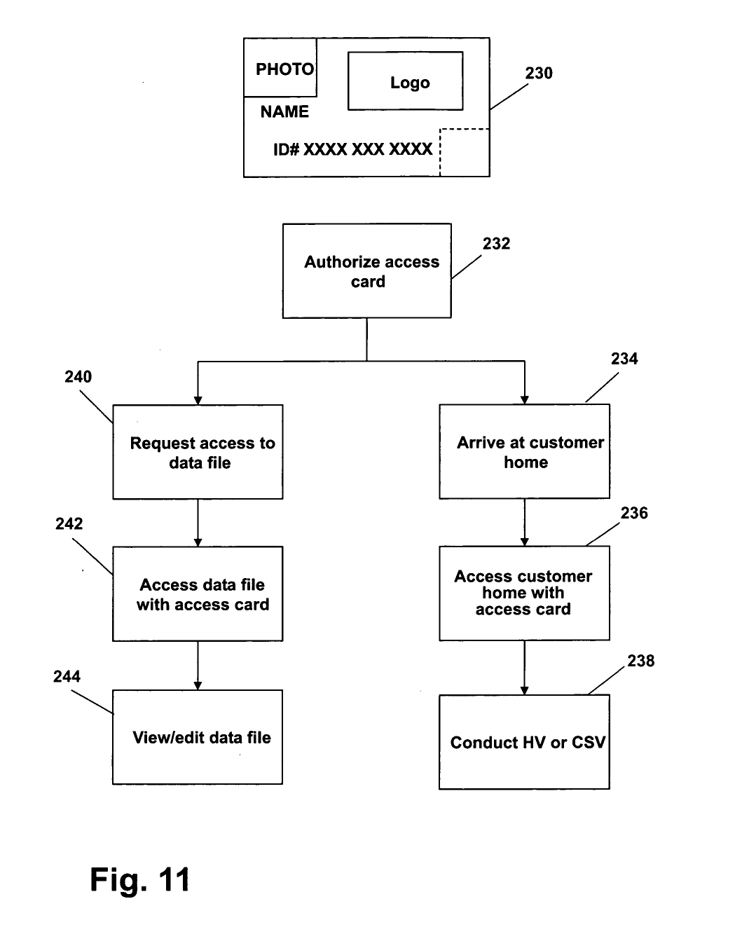

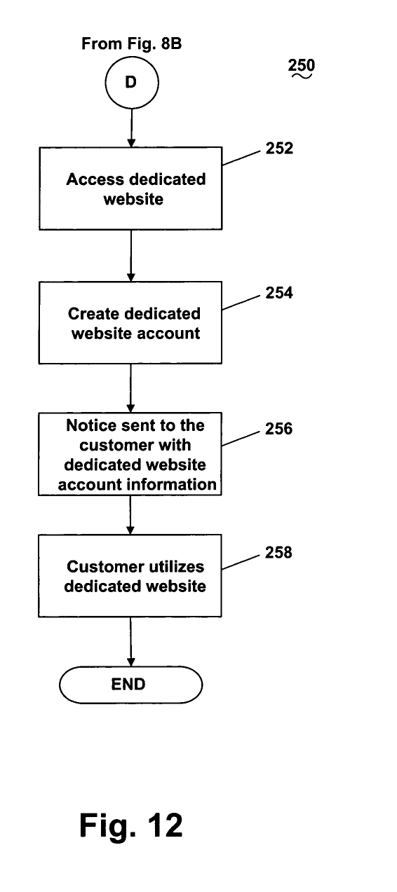

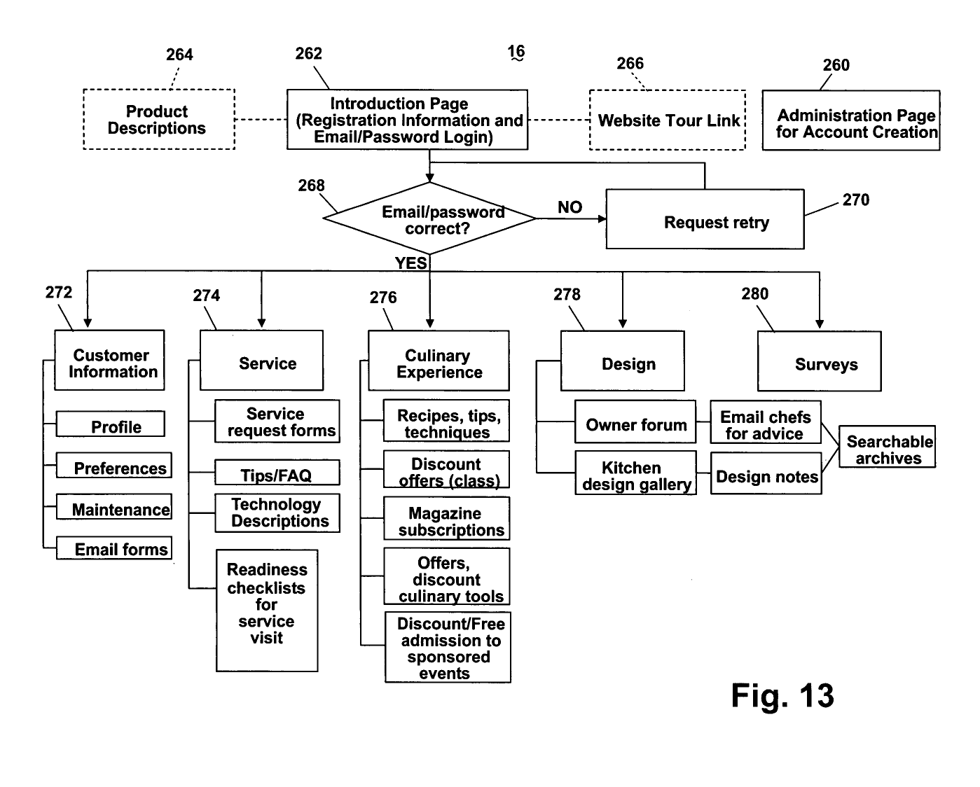

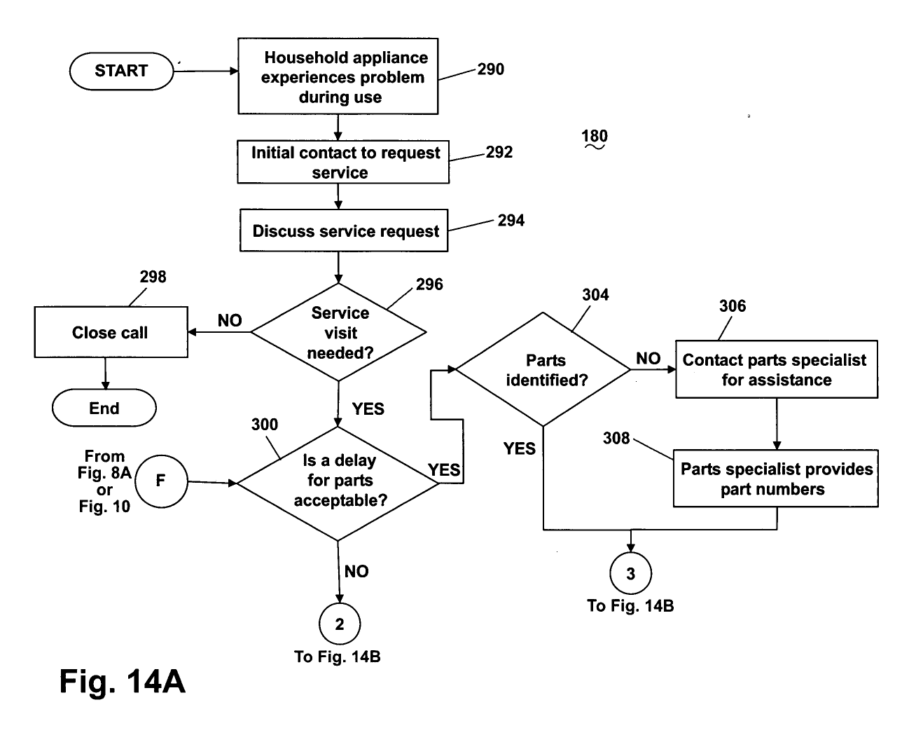

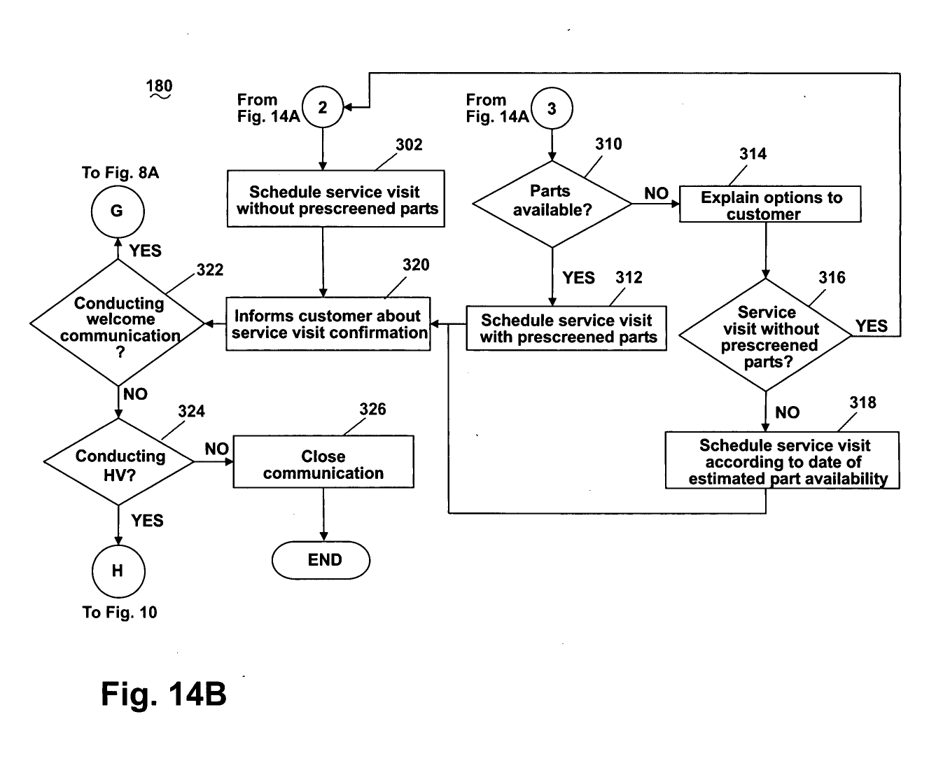

As seen in FIG. 6, delivery and installation 132, whether standard delivery and installation or certified delivery and installation 18, and first use 134 of the household appliance can occur either before or after the welcome communication 140. Both situations are addressed in the flowchart of FIGS. 8A and 8B, which illustrates the general steps of the welcome communication 140. On a predetermined periodic basis, such as daily or weekly, the welcome communications 140 scheduled for that period are identified in step 141. The scheduled welcome communications 140 can be identified by querying the data source 60, or the data source 60 can be programmed to automatically identify the scheduled welcome communications 140. In step 142, the customer 30 is contacted electronically, such as be e-mail, or by telephone and preferably by the CCC 32. After the customer 30 is greeted, the CCC 32 asks whether or not the household appliance is installed in step 144.

If the household appliance is not yet installed, then the CCC 32 requests permission in step 146 to contact the customer 30 after the estimated installation date. If the customer 30 grants permission in step 148, then the CCC 32 updates the customer master data file 68 in step 150 to reschedule the welcome communication 140. On the other hand, if the customer 30 denies permission in step 148, then the customer master data file 68 is updated in step 152 to indicate that a welcome letter and registration kit should be sent to the customer 30.

If the household appliance has been installed, then the CCC 32 asks in step 154 if the household appliance has been used. If the household appliance has been used, then the CCC 32 determines whether there have been any problems with the household appliance and inquires about the performance of the household appliance in step 156. In step 158, the CCC 32 attempts to resolve any problems or issues that were identified by the customer 30 in step 156. The CCC 32 then determines in step 160 whether the service visit is needed, and if the service visit is necessary, then the CCC 32 schedules 180 the service visit, as will be described later.

The CCC 32 continues with the welcome communication 140 and obtains installation information, such as installation date and installation agent, and detailed product information about the household appliance not already contained in the customer master data file 68 in step 162. The CCC 32 then proceeds in step 164 to explain the elements of the customer service system 10, such as the home visit 20 and the dedicated website 16. In step 166, the CCC 32 requests permission to contact the customer 30 at a later date to schedule the home visit 20. If the customer denies permission in step 168, then the CCC 32, in step 170, explains that the home visit 20 can be requested at any time. If the customer 30 grants permission in step 168, then the customer master data file 68 is updated in step 172 to indicate that the customer 30 requests a home visit 20. Alternatively, the CCC 32 can schedule the home visit 20 during the welcome communication 140. Next, the CCC 32 requests in step 174 an e-mail address from the customer 30 so that the CCC 32 can setup a dedicated website account for the customer 30. In step 178, the CCC 32 requests permission to contact the customer 30 in the future and requests the customer's preferred method of contact. Next, the CCC 32 closes the welcome communication 140 in step 178. Following the welcome communication 140, the customer 30 can identify the CCC 32 as a point of contact for the customer service system 10.

After the welcome communication 140, the customer master data file 68 contains sufficient information for a home visit setup 190 and for a dedicated website account setup 250, as shown in FIG. 6. Exemplary steps of the home visit setup 190 are presented in FIG. 9. The CCS 36 is notified in step 192 that a new home visit 20 needs to be scheduled. The CCS 36 confirms in step 144 that the notification has been received, and the customer 30 is contacted in step 196 to schedule the home visit 20 and to confirm that the personal information and the product information in the customer master data file 68 are correct. Confirmation of this information is important because the personalized home visit guide is preferably personalized upon the information. Prior to the home visit 20, the customer 30 is again contacted in step 198 to confirm the date and time of the home visit 20. The above description of the home visit setup 190 assumes that the home visit 20 is setup by the CCS 36. However, as noted previously, the home visit 20 can be scheduled at another time, such as during the welcome communication 140, and by another person in the people network.

Referring now to FIG. 10, at the beginning of the home visit 20, the CCS 36 arrives at a customer home in step 202 and greets the customer 30 in step 204. While greeting the customer 10, the CCS 36 preferably confirms the personal information and the product information. The CCS 36 is preferably equipped with the personal computing device having the remote client 64 and the customer data file 66. The customer data file 66 comprises the personalized home visit guide, which the CCS 36 uses for instruction and for recording information during the home visit 20. Preferably, the personalized home visit guide contains a list, such as a check-off list, of services and steps for performing the services that are to be conducted during the home visit 20.

In step 206, the CCS 36 conducts the services that are available for the household appliance. Examples of such services include checking the household appliance for proper installation, checking the household appliance for proper operation, and instructing the customer 30 about proper operation of the household appliance. When checking the household appliance for proper installation, the CCS 36 can conduct tests on the household appliance and compare the test results to expected results. For example, the temperature of the household appliance can be measured with a portable thermometer, such as a flexible strip that can be placed on or near the household appliance and comprises temperature indicia. Similarly, the humidity in the atmosphere in or near the household appliance can be determined with a portable humidity sensor. The CCS 36 can also check, when appropriate, electrical connections and other connections, such as water or gas line connections, and whether or not the household appliance has been installed in a suitable location within the home. The CCS 36 can check for proper operation of the household appliance by observing user settings on the household appliance to determine whether or not they are properly set and by interviewing the customer 30 about the method in which they operate the household appliance. When the customer 30 operates the household appliance improperly or is unaware of how to operate the appliance correctly, the CCS 36 can instruct the customer 30 on proper usage methods. The instruction can include an overview of basic operation of the household appliance. The CCS 36 can also provide further instruction, even to the customer 30 that knows how to properly operate the household appliance, about unused features and special capabilities of the household appliance, especially the features and capabilities that differentiate the household appliance from other brands. While conducting these services, the CCS 36 can record product information that is not already included in the customer data file 66.

While conducting one or more of the services described above, a problem with the household appliance can be exposed. The CCS 36 responds to the problem and, in step 208, determines whether assistance is needed to solve the problem. If technical assistance is required, the CCS 36 can access problem solving guides and/or contact a technical specialist in step 210. The problem solving guides contain protocols for addressing common problems for the household appliance and potential solutions. The problem solving guides can be physical paper publications or, preferably, electronic files that reside on the personal computing device and are updated periodically by the knowledge base 62. The technical specialist can be contacted by any suitable method, such as by telephone or over the Internet. For example, the technical specialist, the CCS 36, and the customer 30 can participate in a conference call. The technical specialist is highly trained and has access to the server 52 in the communications network 50. The technical specialist works with and guides the CCS 36 to address the problem with the household appliance. After the CCS 36 attempts to repair the problem with the household appliance in step 212, the CCS 36 determines in step 214 whether the problem is sufficiently solved. If the problem has not be solved and the service visit is needed, as determined in step 216, then the service visit is scheduled 180, as will be described later. If the service visit is not required, then the next steps are defined in step 218 before the home visit 20 is complete. It is important that the customer 30 is aware of the next steps and has assurance that the problem will be solved.

After the service visit has been scheduled, the next steps have been defined, or if technical assistance is not needed, the home visit 20 continues in step 220 with a discussion of the customer service system 10 and its benefits. The CCS 36 thoroughly explains the elements of the customer service system 10 that are applicable to the household appliance and answers any questions from the customer 30. The CCS 36 also takes inventory of other household appliances of the same brand or manufacturer so that the other household appliances can be added to the customer master data file 68. Next, the CCS 36 closes the home visit 20 in step 222 and optionally offers the customer 30 a gift.

After the home visit 20 is concluded, the CCS 36 completes a home visit report, which documents the home visit 20. The home visit report is preferably electronic and resides on the personal computing device. However, the home visit report can be any other suitable form, such as on paper. The home visit report can consist of the check-list mentioned above, and the CCS 36 indicates on the report whether or not each service or task was completed. The home visit report can also include notes, comments, or suggestions from the CCS 36 or from the customer 30. Further, the home visit report can also comprise a list of the other home appliances that were inventoried during the home visit 20. The CCS 36 sends the home visit report through the communications network 50, and the customer master data file 68 is subsequently updated. In a preferred embodiment, the CCS 36 transmits the electronic home visit report, either through a wired or wireless connection, directly from the personal computing device to the server 52, as shown schematically in FIG. 5. When the connection is wireless, the data source 60 can be dynamically updated throughout the home visit 20. As discussed previously, the knowledge base 62 updates by accessing the data source 60 with the updated customer master data file 68 containing the home visit report.

Referring now to FIG. 11, the CCS 36 can optionally be issued an access card 230 that, when authorized, provides the CCS 36 access to a customer home or to the customer data file 66. With the access card 230, the CCS 36 can enter the home and conduct at least a portion of the home visit 20, such as checking the household appliance for proper installation, without the customer 30. In some situations, the customer 30 might not be able to guarantee that anyone is present at the home and would prefer that the home visit 20, or portions thereof, is conducted regardless. The access card 230 can also be used to gain access to the customer data file 66 to prevent unauthorized persons from viewing the personal information. For example, the server 52 can require the access card 230 before the customer master data file 68 forms the customer data file 66 and transmits it to the remote client 64. The access card 230 preferably comprises company information, such as an official logo, personal identification information about the CCS 36, such as a name and photo, and access means, such as an identification number, a magnetic strip, or a microprocessor, that can be authorized to enable access to the home or the customer data file 66.

To utilize the access card 230, the access card 230 is authorized in step 232. The CCS 36 can request authorization, or the access card 230 can automatically be authorized, for example when the home visit 20 is scheduled. If the access card 230 is to be used to enter the customer home, the CCS 36 arrives at the customer home in step 234 and accesses the customer home in step 236. Step 236 can be accomplished by entering the identification number into a keypad operably connected to the customer home, or swiping, inserting, or holding the access card 230 through, into, or near, respectively, a card reader operably connected to the customer home. After the access is achieved, the CCS 36 conducts the home visit in step 238. If the access card 230 is to be used to access the customer data file 66, then the CCS 36 connects to the communications network 50 and requests access to the customer data file 66 in step 240. Next, the CCS 36 accesses the customer data file 66 in step 242. If the CCS 36 is using the personal computing device, the CCS 36 can type the identification number or can operably communicate the access card 230 with a card reader connected to the personal computing device. After access is granted, the CCS 36 can view and edit or update the customer data file 66, such as during the home visit 20.

The access card 230 can be utilized for the elements of the customer service system 10 other than the home visit 20. For example, the CSS 38 can have the access card 230 to enter the customer home for the certified service 22 so that the customer 30 does not have to be at the home. As a result, the certified service 22 is convenient for the customer 30 and can be scheduled at any reasonable time during the day.

Optionally, and with permission from the customer 30, the home visit 20 can be visually recorded, such as with a standard video camera. The visual recording of the home visit can be utilized for several purposes. For example, the visual recording can be edited into a reality-based program broadcast on television or on the Internet. The reality-based program could be used as an education tool for the customer 30 and a marketing tool for potential customers. Additionally, the visual recording could be used as a training tool when preparing the CCS 36 to conduct the home visit 20. Further, portions of the visual recording can be incorporated into the dedicated website 16 to enhance its content.

Referring back to FIG. 6, a home visit follow-up 226 is performed after the home visit 20 to ensure that the customer 30 is satisfied with the home visit 20 and to answer any follow-up questions. The home visit follow-up 226 can be in the form of a telephone call or e-mail, depending on the customer's preferred from of contact indicated in step 176.

As stated above, the dedicated website account setup 250 can be conducted after sufficient personal information and product information is obtained, such as during the welcome communication 140. Exemplary steps of the dedicated website account setup 250 are presented in FIG. 12. In step 252, the CCC 32 accesses the dedicated website 16, which is shown schematically in FIG. 13. In particular, the CCC 32 logs into an administration page 260. The CCC 32 enters the appropriate personal information and product information to create the dedicated website account in step 254. In step 256, the customer 30 is automatically sent a notice, preferably by e-mail, with information about the dedicated website 16 and the customer's username and password. Thereafter, the customer 30 can log into and utilize the dedicated website 16 in step 258.

Referring to FIG. 13, the customer 30 initially accesses an introduction page 262, which requests the username and password. The introduction page 262 preferably comprises links to product description pages 264 and to a website tour 266, which can be viewed without entering the username and password so that potential customers can conduct product research and view the benefits of the dedicated website 16 and the customer service system 10. If the customer 30 incorrectly enters the username and password, as determined in step 268, the dedicated website 16 requests that the customer 30 retry entering the username and password in step 270. After the correct username and password are entered, then the customer 30 can view several web pages related to the customer service system 10 and the household appliance. Examples of the web pages include a customer information page 272, a service page 274, a culinary experience page 276, a design page 278, and a survey page 280.

Through the customer information page 272, the customer 30 can view and edit the customer master data file 68, or at least a portion thereof, including the personal information, the product information, and scheduled service visits. This section can also contain forms that the customer 30 can submit to request assistance or ask a question that is not answered elsewhere in the dedicated website 16.

The service page 274 provides access to a plentitude of information, primarily from the knowledge base 62, regarding the household appliance and comprises service request forms that can be submitted to schedule 180 the service visit, as will be described later. The service request forms include information relating to the customer 30 and the household appliance and information needed to provide service on the household appliance. For example, the service request forms can include the personal information, the product information, a description of the problem with the household appliance, scheduling information, such as preferences and availability, and service provider information, such as suggested or preferred service providers and contact information. After the service request form is submitted by the customer 10, information regarding the service request is compiled and entered into the customer master data file 68.

Because the information in the customer master data file 68 is stored in the abbreviated form, the translating client 56 converts the information into the understandable language, as discussed previously, before it is displayed on the dedicated website 16. Similarly, when the customer 30 submits the service request form, the service request form is converted from the understandable language to the abbreviated form before the customer master data file 68 is updated.

The customer 30 can provide feedback information regarding the personal information, the product information, and the service request through the dedicated website 16 and the feedback client 58. For example, the customer 30 can comment on inaccuracies in the personal information, the product information, or the service request viewed on the customer information page 272 and the service page 274. Subsequently, the inaccuracies are updated or corrected in the customer master data file 68. When the feedback information relates to the service request, the feedback information is utilized to refine the service request. For example, if the feedback information indicates that the scheduled date and time are inconvenient for the customer 30, then corresponding changes can be made. Alternatively, the service that is scheduled to be performed on the household appliance can be altered if the feedback information indicates that the scheduled service is not appropriate. As discussed previously, the feedback information is converted to the abbreviated form by the translating client 56 before the customer master data file 68 is updated.

The culinary experience page 276 includes general advice related to cooking, and the design page 278 is geared towards kitchen layout and interior design. These pages 276 and 278 are intended for use by the customer 30 who has purchased a kitchen appliance. The dedicated website 16 could also include pages that are similar to the culinary experience page 276 and the design page 278 but are directed towards other household appliances. The survey page 280 comprises various surveys that the customer 30 can complete to offer input on the dedicated website 16 and on other elements of the customer service system 10. The schematic of the dedicated website 16 in FIG. 13 is for exemplary purposes only, and the content of the pages 272, 274, 276, 278, and 280 is exemplary. The dedicated website 16 can be personalized according to the household appliances that the customer 30 owns and can comprise a variety of web pages having content related to the customer service system 10 and the household appliances.

As mentioned above, the household appliance can experience a problem during operation and can require a service visit 330, which can be a standard service visit or the certified service 22. Referring again to FIG. 6, the problem can be reported or exposed during the welcome communication 140, during the home visit 20, or at another time. Exemplary steps to schedule 180 a service visit 330 are presented in FIGS. 14A and 14B. After the household appliance 290 experiences a problem (step 290) that is discovered by the customer 30 at a time other than during the welcome communication 140 or during the home visit 20, a service request is submitted in step 292. The customer 30 can submit the service request by contacting the CCC 32 by telephone, fax, or e-mail or by submitting the service request form through the dedicated website 16 as described above. Further, the service visit 330 can be scheduled 180 solely through the dedicated website 16 or solely by the voice network. If the service visit request is submitted by telephone or e-mail, the CCC 32 compiles the information regarding the service request and enters it into the master customer data file 68 through the client 54. After the service request is discussed in step 294, the CCC 32 determines in step 296 whether the service visit 330 is needed. If the service visit 330 is not required to fix the problem, then the CCC 32 closes the call in step 298 after the customer 30 understands how to solve the problem. If the service visit 330 is needed, then the customer 30 is asked in step 300 if it is acceptable to delay the service visit 330 by a predetermined period of time in order to obtain prescreened parts potentially required for the service visit 330. In cases where the problem was reported during the welcome communication 140 (FIGS. 8A and 8B) or during the home visit 20 (FIG. 10), the process to schedule 180 the service visit 330 merges at step 300.

If the delay for the prescreened parts is not acceptable, then the service visit 330 without the prescreened parts is scheduled in step 302. However, if the customer 30 is willing to wait for the prescreened parts, then the CCC 32 determines if the prescreened parts can be identified in step 304. If not, then a parts specialist is contacted for assistance in step 306, and the parts specialist provides the part numbers in step 308. Next, the CCC 32 determines in step 310 if the prescreened parts are available. If the prescreened parts are available, then the service visit 330 with the prescreened parts is scheduled in step 312. However, if the prescreened parts are not available, then the CCC 32 explains options to the customer 30 in step 314 and determines in step 316 whether the customer 30 is unwilling to wait for delivery and would like to schedule the service visit 330 without the prescreened parts. If the customer 30 does not want to wait, then the service visit 330 without the prescreened parts is scheduled in step 302. On the other hand, if the customer wants to wait for the prescreened parts, then the service visit 330 is scheduled in step 318 according to a date of estimated prescreened part availability.

After the service visit 330 is scheduled, then the customer 30 is informed in step 320 of the date and time of the service visit 330 and that a confirmation notice will be sent to the customer 30. If the problem was reported during the welcome communication 140 (step 322), then the welcome communication continues. If the problem was reported during the home visit 20 (step 324), then the home visit 20 continues. Otherwise, the CCC 32 closes the communication in step 326. After the service visit 330 is executed, the customer 10 receives a follow-up communication, such as a home visit, a telephone call, or an e-mail, to check the status of the problem and to ensure that the household appliance is not experiencing any other problems.

Referring again to FIG. 6, the customer 30 receives a periodic checkup communication 340 as part of the customer service system 10. The periodic checkup communication 340 reminds the customer 30 about the customer service system 10 and checks to determine whether there are any problems with the household appliance or whether the customer 30 has any questions related to the household appliance or the customer service system 10.

The customer service system 10 according to the invention is intended to meet and exceed customer expectations and, consequently, instill loyalty to the brand of the household appliance. By having a dedicated customer service representative 32 that can be contacted directly, the customer 30 can associate a name and a face with the customer service system 10 and have confidence that the representative will help with any questions, concerns, or problems. Additionally, because the customer 30 has access to at least a portion of same personal and product information that the representative 32 views, communication between the customer 30 and the representative is effective and efficient. The dedicated website 16 also facilitates effective communication, in addition to providing an excellent source of educational material related to the household appliance. Further, the home visit 20 shows the customer 10 that the brand is committed to customer service and is willing to spend time and resources to make certain that the household appliance is properly installed and operated. These elements and others, such as the certified delivery and installation and the certified service, of the customer service system 10 ensure that the customer 30 is pleased with the purchase of the household appliance throughout the delivery and installation, operation, and service thereof.

While the invention has been specifically described in connection with certain specific embodiments thereof, it is to be understood that this is by way of illustration and not of limitation, and the scope of the appended claims should be construed as broadly as the prior art will permit.

What is claimed is:

1. A method for providing customer service for a household appliance sold at a point of sale (POS) to a customer and subsequently installed in the customer's home, the method comprising:
Visiting the customer's home after the installation of the household appliance to conduct at least one of the following services: checking the household appliance for proper installation, checking the household appliance for proper operation, and instructing the customer on the operation of the household appliance.

2. The method according to claim 1 wherein all of the services are conducted during the visit.

3. The method according to claim 1 wherein a representative of a wholesaler of the household appliance conducts the visit.

4. The method according to claim 3 wherein the representative is one of an employee or non-employee of the wholesaler.

5. The method according to claim 1 and further comprising recording product information for the household appliance during the visit.

6. The method according to claim 5 wherein the product information is recorded on a client device capable of being connected to a server having an associated data source for storing the recorded product information.

7. The method according to claim 6 wherein the client device is at least one of a: portable computer, hand-held computing device, a personal digital assistant, or cellular phone.

8. The method according to claim 7 wherein the client device is wirelessly connected to the server to dynamically update the data source with the product information.

9. The method according to claim 1 and further comprising accessing customer information containing at least one of customer personal information and product information for the household appliance during the visit.

10. The method according to claim 9 and further comprising confirming at least one of the customer information and product information during the visit.

11. The method according to claim 10 wherein both the customer information and product information are confirmed during the visit.

12. The method according to claim 1 and further comprising explaining the service benefits to the customer for the household appliance.

13. The method according to claim 1 and further comprising responding to a problem identified when providing one of the services.

14. The method according to claim 13 wherein the response to the identified problem comprises at least one of: accessing help information and placing a service request for service on the household appliance.

15. The method according to claim 14 wherein accessing help information comprises at least one of: placing a call to a technical specialist and accessing problem solving guides.

16. The method according to claim 15 wherein accessing problem solving guides comprises accessing a knowledge base.

17. The method according to claim 16 and further comprising updating the knowledge base with a description of the identified problem.

18. The method according to claim 15 wherein the placing of a call to the technical specialist comprises a conference call with the customer.

19. The method according to claim 14 and further comprising providing the customer with access to information related to the scheduling of the service request.

20. The method according to claim 19 and further comprising receiving feedback from the customer regarding the information for the service request.

21. The method according to claim 20 and further comprising incorporating the customer feedback into the service to be provided in response to the service request.

22. The method according to claim 21 wherein incorporating the feedback into the service comprises altering at least one of the: service on the household appliance and the date or time of a service visit.

23. The method according to claim 22 and further comprising providing the service visit on the household appliance in accordance with the information for the service request.

24. The method according to claim 20 wherein access is provided to only a portion of the information for the service request.

25. The method according to claim 20 wherein access is provided to the information for the service request through a communications network.

26. The method according to claim 25 wherein the communications network is the Internet.

27. The method according to claim 20 and further comprising updating a knowledge base with at least one of the information for the service request and the feedback.

28. The method according to claim 27 and further comprising providing the customer with access to at least a portion of the knowledge base.

29. The method according to claim 28 and further comprising providing others with access to the at least a portion of the knowledge base.

30. The method according to claim 14 wherein the placing of the service request comprises confirming the date of the service visit with the customer.

31. The method according to claim 14 and further comprising contacting the customer after the service visit to determine the status of the problem.

32. The method according to claim 31 wherein the contacting the customer comprises at least one of: a home visit, a telephone call, and an e-mail.

33. The method according to claim 1 and further comprising making a visual recording of the visit.

34. The method according to claim 33 and further comprising making at least a portion of the visual recording available to at least the customer.

35. The method according to claim 33 and using at least a portion of the visual recording to form a reality-based program.

36. The method according to claim 1 wherein the checking of the household appliance for proper installation comprises checking at least one of the temperature and humidity of the household appliance.

37. The method according to claim 1 wherein the instructing of the customer on the operation of the household appliance comprises conducting an overview of the basic operation of the household appliance.

38. The method according to claim 1 wherein the instructing of the customer on the operation of the household appliance comprises conducting an overview of special features of the household appliance.

39. The method according to claim 1 and further comprising scheduling the visit with the customer prior to the visit.

40. The method according to claim 39 wherein the scheduling of the visit comprises communicating with the customer to set the date of the visit.

41. The method according to claim 40 wherein the communication comprises at least one of telephoning or e-mailing the customer.

42. The method according to claim 39 and further comprising reviewing customer information at least one of: prior to the visit and during the visit.

43. The method according to claim 42 and further comprising explaining the service benefits for the household appliance to the customer.

44. The method according to claim 43 and further comprising responding to a problem identified when providing one of the services.

45. The method according to claim 44 and further comprising updating the customer information in response to the visit.

46. The method according to claim 45 and further comprising updating a customer service database with the customer information.

47. The method according to claim 46 and further comprising providing the customer with access to at least a portion of the customer information.

48. The method according to claim 46 and further comprising visually recording the visit.

49. A method for providing customer service for a household appliance sold to a customer, comprising:
receiving a service request for providing service to the household appliance;
compiling information regarding the service request;
providing the customer with access to the compiled service request information; and
receiving feedback from the customer regarding the compiled service request information.

50. The method according to claim 49 and further comprising updating the compiled service request information based on the feedback from the customer.

51. The method according to claim 50 and further comprising incorporating the customer feedback into the service to be provided in response to the service request.

52. The method according to claim 51 wherein incorporating the feedback into the service comprises altering at least one of the: service on the household appliance and the date or time of a service visit.

53. The method according to claim 51 and further comprising providing service on the household appliance in accordance with the compiled service request information.

54. The method according to claim 49 wherein access is provided to only a portion of the compiled service request information.

55. The method according to claim 49 wherein access is provided to the compiled service request information through a communications network.

56. The method according to claim 55 wherein the communications network is the Internet.

57. The method according to claim 49 and further comprising updating a knowledge base with at least one of the compiled service request information and the feedback.

58. The method according to claim 57 and further comprising providing the customer with access to at least a portion of the knowledge base.

59. The method according to claim 58 and further comprising providing others with access to the at least a portion of the knowledge base.

60. A system for providing service for a household appliance sold to a customer, comprising:
a server operably interconnected to a network having at least one client;
a data source associated with the server, the data source being configured to store information representative of a service request for the household appliance and accessible by the at least one client;
a feedback client operably interconnected with the network for receiving feedback information representative of a comment on the service request made by the customer;
wherein the at least one client can issue the information representative of the service request to the data source, and the feedback client can issue the at least one comment to the data source so that the customer service provided to the household appliance in accordance with the service request can be refined according to the at least one comment received from the feedback client.

61. The system according to claim 60 wherein the information representative of the service request comprises at least the information needed to provide service on the household appliance.

62. The system according to claim 61 wherein the information representative of the service request comprises at least one of: description of the problem with the household appliance; model of the household appliance; scheduling information for a service visit; customer personal information; and service provider information.

63. The system according to claim 60 wherein the information representative of the service request is stored in an abbreviated form.

64. The system according to claim 63 wherein the abbreviated form comprises at least one of: acronyms and service codes.

65. The system according to claim 63 and further comprising a translating client accessible by the data source and the feedback client to convert the abbreviated form to a language understandable by the customer.

66. The system according to claim 65 wherein the language is at least one of:
English, German, Spanish, Italian, and French.

67. The system according to claim 65 wherein the translating client creates the feedback information representative of the customer comment by converting the customer comment into the abbreviated form.

68. The system according to claim 67 wherein translating client comprises at least one of: a human, a microprocessor, or software.

69. The system according to claim 60 wherein the at least one client comprises at least one of: a human, a microprocessor, or software.

70. The system according to claim 69 wherein the human receives the service request and uses the at least one client to enter the information representative of the service request into the data source.

71. The system according to claim 70 and further comprising a voice network over which the human receives the service request.

72. The system according to claim 69 wherein the at least one client comprises an Internet browser.

73. The system according to claim 60 wherein the server comprises a web server.

74. The system according to claim 60 wherein the data source comprises at least one database.

75. The system according to claim 74 wherein the feedback client is operably interconnected to the at least one database so that the customer can access at least a portion of the data source.

76. The system according to claim 74 wherein the feedback client is associated with the data source such that the customer comment is used to update the data source.

77. The system according to claim 76 wherein the database resides on the server.

78. The system according to claim 60 wherein the network comprises at least one of: the Internet, a Local Area Network, a wireless network, and the World Wide Web.

79. The system according to claim 78 wherein the feedback client comprises a web browser operably connected to the network.

80. The system according to claim 79 and further comprising a personal computing device on which the web browser resides.

81. The system according to claim 80 wherein the personal computing device comprises at least one of: a personal computer, a handheld computer, a personal digital assistant, a cellular phone.

82. The system according to claim 81 wherein the feedback client further comprises a web site associated with the server so that the data source can be viewed on the web site using the web browser.

83. The system according to claim 60 and further comprising at least one data file containing information for conducting a home visit of the household appliance.

84. The system according to claim 83 wherein the at least one data file comprising information for conducting at least one of the following: checking the household appliance for proper installation, checking the household appliance for proper operation, and instructing the customer on the operation of the household appliance.

85. The system according to claim 83 and further comprising a computing device on which the at least one data file resides.

86. The system according to claim 85 wherein the computing device is operably connected to the network to permit the updating of the at least one data file via the network.

87. The system according to claim 86 wherein the at least one data file is associated with the data source so that the at least one data file can be updated from the data source.

88. The system according to claim 87 wherein the data source includes at least one of customer personal information and product information for the household appliance so that the at least one data file can be personalized for at least one of the customer and the household appliance for the home visit.

89. The system according to claim 88 and further comprising a remote client residing on the computing device and providing an interface with the at least one file and permitting the reading and writing of the data file so that the at least one data file can be updated by the remote client.

90. The system according to claim 89 wherein the remote client is operably coupled to the network to permit the updating of corresponding data in the data source and the at least one data file when the data file is written to by the remote client.

91. The system according to claim 90 wherein the computing device comprises at least one of a personal computer, a handheld computer, a personal digital assistant, a cellular phone.

92. The system according to claim 86 the data source comprises at least one master data file to form the at least one data file that can be downloaded to the computing device over the network.

93. The system according to claim 92 wherein the data source further comprises a compilation of the household appliance information and feedback information which is used to update the master data file.

94. A method for providing personalized customer service for a specific brand of a household appliance sold to a customer by a wholesaler selling multiple brands of household appliances, comprising:
providing multiple service representatives dedicated to the specific brand;
assigning one of the multiple service representatives to the customer to personally manage the customer service for the specific brand; and
providing access by the customer to customer information related to the customer service.

95. The method according to claim 94 and further comprising receiving feedback from the customer regarding the customer information.

96. The method according to claim 95 wherein the customer information comprises personal information and product information.

97. The method according to claim 95 and further comprising updating the customer information based on the feedback from the customer.

98. The method according to claim 97 wherein the customer information comprises a service request for the household appliance.

99. The method according to claim 98 and further comprising providing a service visit on the household appliance in accordance with the updated customer information.

100. The method according to claim 99 wherein updating the customer information comprises altering at least one of the: service on the household appliance and the date or time of the service visit.

101. The method according to claim 95 and further comprising updating a knowledge base with at least one of the customer information and the feedback.

102. The method according to claim 101 and further comprising providing the customer with access to at least a portion of the knowledge base.

103. The method according to claim 102 and further comprising providing others with access to the at least a portion of the knowledge base.

104. The method according to claim 94 wherein access is provided to only a portion of the customer information.

105. The method according to claim 94 wherein access is provided to the customer information through a communications network.

106. The method according to claim 105 wherein the communications network is the Internet.

107. The method according to claim 94 and further comprising visiting the customer's home after installation of the household appliance to provide at least one of the following services: checking the household appliance for proper installation, checking the household appliance for proper operation, and instructing the customer on the operation of the household appliance.

108. The method according to claim 107 and further comprising providing the services in accordance with a visit guide containing predetermined service steps.

109. The method according to claim 108 wherein the visit guide is personalized with at least one of personal information and product information for the household appliance to be serviced.

110. The method according to claim 109 and further comprising dynamically updating the visit guide.

111. The method according to claim 109 and further comprising updating at least one of the personal information and product information in response to the home visit.

112. The method according to claim 107 wherein all of the services are provided during the visit.

113. The method according to claim 112 and further comprising recording product information for the household appliance during the visit.

114. The method according to claim 113 and further comprising explaining the service benefits to the customer for the household appliance.

115. The method according to claim 107 and further comprising responding to a problem identified when providing one of the services.

116. The method according to claim 115 wherein the response to the identified problem comprises at least one of: accessing help information and placing a service request for service on the household appliance.

117. The method according to claim 116 wherein accessing help information comprises at least one of: placing a call to a technical specialist and accessing a problem solving guide.

118. The method according to claim 117 wherein the placing of a call to the technical specialist comprises a conference call with the customer.

119. The method according to claim 107 and further comprising making a visual recording of the visit.

120. The method according to claim 119 and further comprising making at least a portion of the visual recording available to at least the customer.

121. The method according to claim 120 and using at least a portion of the visual recording to form a reality-based program.

122. The method according to claim 94 and further comprising providing household appliances of the specific brand with an enhanced warranty as compared to household appliances of the other brands.

123. The method according to claim 122 and further comprising receiving feedback from the customer regarding the customer information.

124. The method according to claim 123 and further comprising visiting the customer's home after the installation of the household appliance to provide at least one of the following services: checking the household appliance for proper installation, checking the household appliance for proper operation, and instructing the customer on the operation of the household appliance.

125. The method according to claim 124 and further comprising providing the services in accordance with a visit guide containing predetermined service steps.

126. The method according to claim 125 wherein all of the services are provided during the visit.

127. The method according to claim 124 wherein access to the customer's home is obtained with an authorized access card.

128. The method according to claim 123 wherein the customer information comprises a service request for the household appliance, and the feedback is incorporated into the service request to update the service request.

129. The method according to claim 128 and further comprising providing a service visit on the household appliance in accordance with the updated service request.

130. The method according to claim 94 and further comprising installing the household appliance by a certified installation agent.

131. The method according to claim 94 and further comprising conducting a service visit by a service specialist to address a problem associated with the household appliance.

132. The method according to claim 131 wherein the service specialist has a personal computing device with access to the customer information.

133. The method according to claim 132 wherein the personal computing device has access to a service guide.

134. The method according to claim 133 wherein the service guide is updated by a knowledge base.

135. The method according to claim 94 and further providing a customer service website for providing access to the customer information by the customer.

136. The method according to claim 135 wherein the customer can provide feedback regarding the customer information through the customer service website.

137. The method according to claim 136 wherein the customer service website comprises a service request form that can be submitted by the customer.
